(19) United States
(12) Patent Application Publication
(10) Pub. No.: US 2023/0095693 A1
(43) Pub. Date: Mar. 30, 2023

(54) HIGH INTRINSIC QUALITY RECEIVER CONSTRUCTION

(71) Applicant: Yank Technologies, Inc., Brooklyn, NY (US)

(72) Inventor: Joshua Aaron YANKOWITZ, Brooklyn, NY (US)

(73) Assignee: Yank Technologies, Inc., Brooklyn, NY (US)

(21) Appl. No.: 17/905,470

(22) PCT Filed: Mar. 5, 2021
(86) PCT No.: PCT/US2021/021088

§ 371 Date: Sep. 1, 2022

Related U.S. Application Data
(60) Provisional application No. 62/985,799, filed on Mar. 5, 2020.

(51) Int. Cl. H02J 50/70; H02J 50/10

(52) U.S. Cl. CPC H02J 50/70; H02J 50/10

(57) ABSTRACT

A receiver system for a wireless charging system includes a receiver antenna forming a first planar layer; a shielding material adjacent to the receiver antenna, the shielding material forming a second planar layer; and a dielectric separation material layer disposed between the receiver antenna and the shielding material layer, wherein the dielectric separation material comprises a thickness of 0.1 mm or higher and a dissipation factor of 0.01 or lower at a 1 MHz frequency, and wherein the dielectric separation material is configured to maintain an intrinsic quality factor “Q” value of the receiver antenna above a target intrinsic Q value.

### RELATED APPLICATIONS

This application claims priority to and benefit from U.S. Provisional Patent Application No. 62/985,799, entitled “HIGH INTRINSIC QUALITY RECEIVER CONSTRUCTION,” filed on Mar. 5, 2020, which is hereby incorporated by reference in its entirety.

### BACKGROUND

In recent years, products that allow wireless charging of electronic equipment have gained popularity. Future trends may be that practically many pieces of equipment that operate using battery power, may be wirelessly charged.

### BRIEF SUMMARY

Various techniques for implementing a high intrinsic quality receiver are disclosed. These techniques may be used by embodiments of wireless charging systems for constructing a wireless charging system receiver including a dielectric separation layer disposed between a shielding material layer and a receiver antenna where the properties and thickness of dielectric separation layer prevents the shielding material layer from reducing the intrinsic quality factor of the receiver antenna.

In one example aspect, a receiver system for a wireless charging system is disclosed. The receiver system includes a receiver antenna forming a first planar layer; a shielding material adjacent to the receiver antenna, the shielding material forming a second planar layer; and a dielectric separation material layer disposed between the receiver antenna and the shielding material layer, wherein the dielectric separation material comprises a thickness of 0.1 mm or higher and a dissipation factor of 0.01 or lower at a 1 MHz frequency, and wherein the dielectric separation material is configured to maintain an intrinsic quality factor “Q” value of the receiver antenna above a target intrinsic Q value.

In another example embodiment, a method for fabricating a receiver system for a wireless charging system is disclosed. The method includes forming a receiver antenna on a first planar layer; forming a first dielectric separation material on a second planar layer; forming a shielding material on a third planar layer, wherein the second planar layer is disposed between the first planar layer and the third planar layer, and wherein the first dielectric separation material is configured to maintain an intrinsic quality factor “Q” value of the receiver antenna above a target intrinsic Q value, and wherein the first dielectric separation material has a dissipation factor of 0.01 or lower at a 1 MHz frequency, and a thickness of 0.1 mm of larger.

These, and other, aspects are disclosed throughout the present document.

### BRIEF DESCRIPTION OF THE DRAWINGS

FIG. 1A is a representative receiver system construction for a wireless charging system.

FIG. 1B is another representative receiver system construction for a wireless charging system.

FIG. 2A is a representative receiver system construction for a wireless charging system for a high intrinsic quality receiver antenna.

FIG. 2B is another representative receiver system construction for a wireless charging system for a high intrinsic quality receiver antenna.

FIG. 3 is a representative illustration of a receiver system construction for a wireless charging system including shielding and dielectric separation material.

FIG. 4A is a representative first perspective view of a receiver system embedded in a phone case.

FIG. 4B is a representative second perspective view of a receiver system embedded in a phone case.

FIG. 4C is a representative view of a fully assembled phone case.

FIG. 5 shows a flowchart for a method of fabricating a receiver system.

### DETAILED DESCRIPTION

The intrinsic quality factor or “Q” value of a receiver antenna for a wireless charging system is an important factor in determining how well the wireless charging system performs. The Q of the antenna is a measure of the energy dissipated in the antenna relative to the energy stored in the antenna and is a barometer for the efficiency of the antenna. The higher the Q, the better the antenna can couple electromagnetic fields, which can result in more power delivered to a load.

Conventional wireless charging system receivers are typically not constructed to optimize the intrinsic Q of the antenna. For example, resonant inductive charging pads typically operate when a smartphone or tablet is physically placed on top of the charging pad.

The description that follows describes systems and methods for constructing a wireless charging system receiver including a dielectric separation layer disposed between a shielding material layer and a receiver antenna, where the properties and thickness of dielectric separation layer prevents the shielding material layer from reducing the intrinsic quality factor of the receiver antenna (i.e., from de-Qing the receiver antenna).

Various embodiments will now be described. The following description provides specific details for a thorough understanding and an enabling description of these embodiments. One skilled in the art will understand, however, that the invention can be practiced without many of these details. Additionally, some well-known structures or functions may not be shown or described in detail, to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

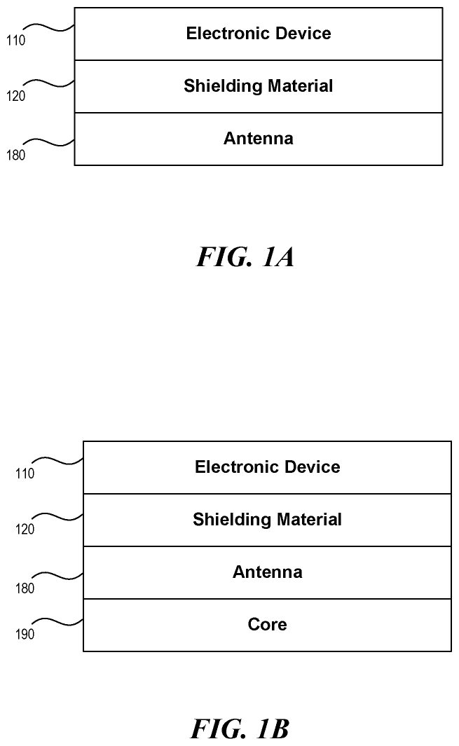

FIG. 1A is a representative receiver system construction for a conventional wireless charging system. If the electronic device 110 (e.g., smartphone, tablet, etc.) does not have a wireless charging chip embedded in the electronic device, the receiver construction typically is as illustrated in FIG. 1A where the electronic device 110 normally has the receiver sandwiched between the device and the device's case or embedded directly into the device's case. The receiver includes a shielding layer or shielding material 120 between the device 110 and a receiver antenna 180. The shielding material 120 can be a high permeability, low loss material at the wireless power transmission frequency, such as 100 kHz or 6.78 MHz. This construction method is also typical for wireless charging receivers embedded directly into devices.

In FIG. 1B, the receiver system of FIG. 1A can also include a core 190 placed around (e.g., below and/or on the sides of and/or in the center of) the antenna 180 to confine the magnetic flux to the area around the antenna 180.

The quality factor (“Q”) of the antenna 180 is degraded in the receiver construction of FIG. 1A and FIG. 1B. There are several reasons why the receiver construction of FIG. 1A and FIG. 1B de-Qs the receiver antenna. For example, because the shielding material 120 is in direct contact with the receiver antenna 180, it can add additional resistance to the antenna 180 thereby reducing the antenna's intrinsic Q. This may seem counter-intuitive because the shielding material 120 is typically intended to shield the receiver antenna 180 from the electronic device such as a smartphone. However, although the shielding material 120 might partially shield the antenna 180 from the metallic or conductive structures in the electronic device 110, the shielding material 120 also reduces the intrinsic Q of the receiver antenna 180 by introducing additional resistance by being in contact with the antenna traces. This results in further degradation of the intrinsic Q of the receiver antenna 180.

Although the receiver construction of FIG. 1A and FIG. 1B might operate fine for low power signals, for example, signals used for radio frequency identification (RFID) tags, these constructions are not effective or efficient for wireless power transfer, particularly for transfer of high power in the milliwatt range and above and for high frequency signals. Applications where the physical separation between a transmitter (e.g., the wireless charging pad) and a receiver (e.g., a smartphone) is small (e.g., a few millimeters) may not require a high intrinsic Q receiver antenna. The need for a high intrinsic Q can also be relaxed in other applications such as RFID tags where the main design focus might be signal integrity rather than power efficiency. However, maintaining a high intrinsic Q is an important design criterion in applications where the transmitter and the receiver are physically placed far apart, e.g., for loosely-coupled wireless charging systems. A high intrinsic Q is also an important design criterion in applications where the power efficiency is particularly important, e.g., in low power or battery-operated systems. There is therefore a need for a construction method that maintains the high intrinsic Q of the receiver antenna. An example of a high intrinsic Q is a Q greater than around 100 (e.g., between 200 and 800).

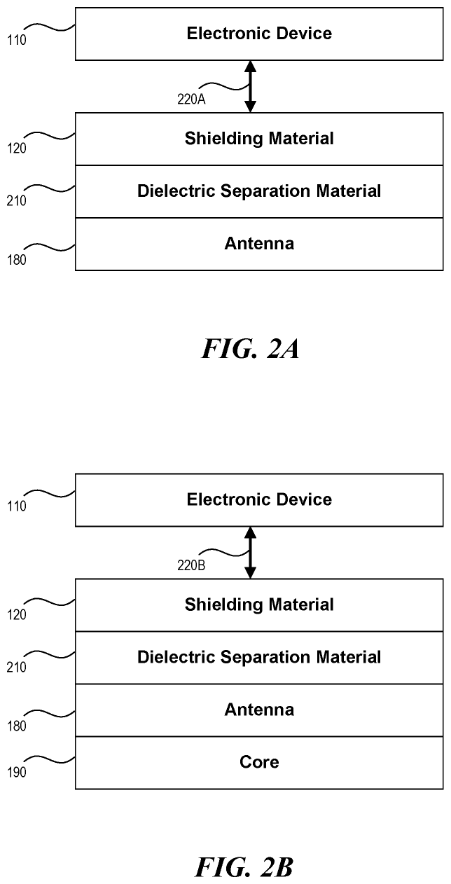

FIG. 2A is a representative receiver construction for a wireless charging system that implements and maintains a high intrinsic quality receiver antenna. In the construction of FIG. 2A, a dielectric separation material layer 210 is placed between the antenna 180 and the shielding material layer 120. The electronic device 110 is placed in proximity to the shielding material 120. In some embodiments, the electronic device 110 is separated from the shielding material 120 by a distance 220A. In some embodiments, the spacing 220A is zero or the electronic device is placed directly on the shielding material 120. In other embodiments, the spacing 220A can be a fixed spacing due to the material of a case, e.g., the plastic material of a phone or tablet case, where the spacing material can be similar to the dielectric separation material.

The dielectric separation material 210 acts as a physical buffer between the receiver antenna 180 and the shielding material 120. Unlike the shielding material 120 which de-Qs the receiver antenna as discussed above, the dielectric separation material 210 has certain properties required to maintain the antenna's intrinsic efficiency, for example, a low dissipation factor and a low dielectric constant. In some embodiments, the dielectric separation material 210 can be polypropylene plastic with a dissipation factor of around 0.0003 at 1 MHz, and a dielectric constant of around 2.2 at 1 MHz. Therefore, the physical contact of the antenna with the dielectric separation material 210 will have a minimal impact on reducing the intrinsic efficiency of the receiver antenna 180.

It is generally desirable for the dielectric separation material 210 to be several millimeters thick. However, the thickness of the dielectric separation material 210 can be reduced to allow it to fit within the size constraints of the intended application. For example, smartphone receiver accessories can be very thin (e.g., 1-2 mm), in order to physically fit between a smartphone and a phone case. Similarly, the receivers need to be thin (e.g. 1 to 3 mm) in order fit inside a retrofitted phone case with the receiver embedded inside. In such applications, the dielectric separation material would need to be thinner. For example, a dielectric separation material 210 with a thickness of at least 0.1 mm and a dissipation factor of 0.01 or lower at around 1 MHz test frequency can more effectively physically isolate the receiver antenna 180 from the shielding material 120.

In some embodiments, the shielding material 120 can be ferrite, the dielectric separation material 210 can be made from polycarbonate plastic sheets with a thickness of approximately 0.1 mm or greater (e.g., a 0.4 mm individual or combined thickness), and the receiver antenna can be connected to its respective printed circuit board (PCB). In this construction, the receiver can have minimal (e.g., 0.1 mm) to zero spacing between the electronic device and the shielding material. That is, the spacing 220A can be close to zero. In some embodiments, the dielectric separation material can be between approximately 0.2 mm to approximately 0.5 mm in thickness, but it can have a wider range depending on the selected receiver construction.

In some embodiments, a separator can occupy the spacing 220A between the shielding material and the electronic device. The separator can be another low dissipation factor material like polycarbonate plastic with a thickness of approximately 0.4 mm. For example, the separator in the spacing 220A can be a low dissipation factor plastic in a receiver case, such as in a phone or tablet case.

FIG. 2B is another representative receiver construction for a wireless charging system for a high intrinsic quality receiver antenna. In FIG. 2B, a core 190 is disposed below the antenna to help confine the magnetic flux to the area of the antenna. In some embodiments, depending on the antenna construction, the core 190 can be around the antenna, in the center of the antenna, or otherwise positioned relative to the antenna to confine the generated magnetic flux to an area around, inside, or near the antenna.

In one embodiment the antenna can include one or more coils where each coil is arranged as a surface spiral coil made up of a continuous conductor with no breaks or radio frequency discontinuities. The conductor can be wound around a dielectric material at an angle to diminish the proximity effect at an operational frequency of the wireless charging transmitter device, and to maintain a high intrinsic quality factor (“Q”) of the surface spiral coil at the operating frequency. The continuous conductor can have a thickness approximately of 40 um.

To fabricate the receiver for the wireless charging system, the receiver antenna 180 can be formed on a first planar layer, the dielectric separation material 210 can be formed on a second planar layer, and the shielding material 120 can be formed on a third planar layer such that the second planar layer is disposed between the first planar layer and the third planar layer (i.e., the dielectric separation material 210 forming the second layer is sandwiched between the receiver antenna 180 and the shielding material 120). The dielectric separation material is configured to maintain an intrinsic quality Q of the receiver antenna above a target intrinsic Q value, has a thickness of at least 0.1 mm, and has a dissipation factor of 0.01 or lower at around 1 MHz test frequency for the selected dielectric separation material.

In some embodiments, a core can be formed around the antenna 180 to confine the magnetic flux generated by antenna 180 to an area around the antenna 180. Furthermore, the area within the separation distance 220B can include a second dielectric separation material on a fourth planar layer, where the fourth planar layer is disposed between the third planar layer (shielding material 120) and an electronic device 110. Like the first dielectric separate material layer between the antenna 180 and shielding material layer 120, the second dielectric separation material layer is configured to maintain an intrinsic Q of the receiver above a target intrinsic Q value by having the separation material maintain certain properties. The second dielectric separation material can have a thickness of 0.01 or lower at around 1 MHz test frequency. In some embodiments, for example, in resonant inductive systems, the target intrinsic Q value is at least 100. In other embodiments, the target intrinsic Q value is at least 700. The second dielectric separation material, e.g., the middle frame of a phone case, needs to have certain properties (e.g., certain dissipation factor) to not degrade the receiver's performance. For example, the intrinsic Q can decrease by more than 50% if a high dissipation factor plastic (e.g., ABS plastic) is used for either the first or second dielectric separation material. Furthermore, the intrinsic Q can also decrease by more than 50% if the traces of the antenna contact the shielding material directly (e.g., in FIG. 1A and FIG. 1B construction methods).

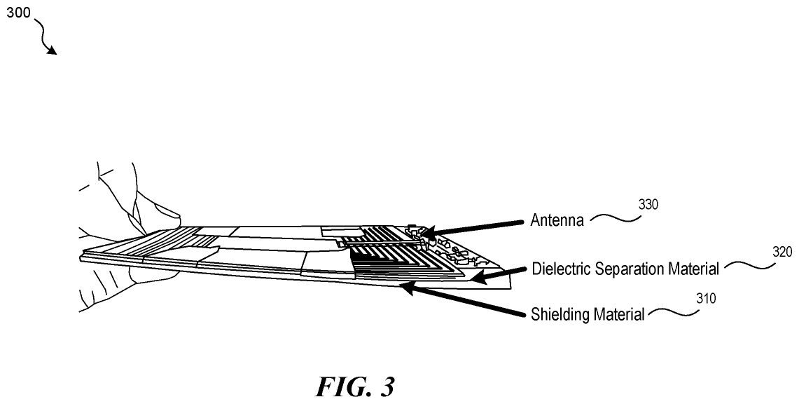

FIG. 3 is a representative illustration of a receiver construction for a wireless charging system including shielding and dielectric separation material. The representative embodiment disclosed in this illustration includes a shielding material 310 (e.g., ferrite shielding material); a dielectric separation material 320 (e.g., composed of one or more polycarbonate plastic sheets of approximately 0.4 mm in total thickness); and a receiver antenna 330 connected to its respective PCB. In one embodiment, the dielectric separation material 320, with a dissipation factor of 0.01 or lower at approximately 1 MHz frequency and a thickness of at least 0.1 mm, adequately physically isolates the receiver antenna 330 from the shielding material 310.

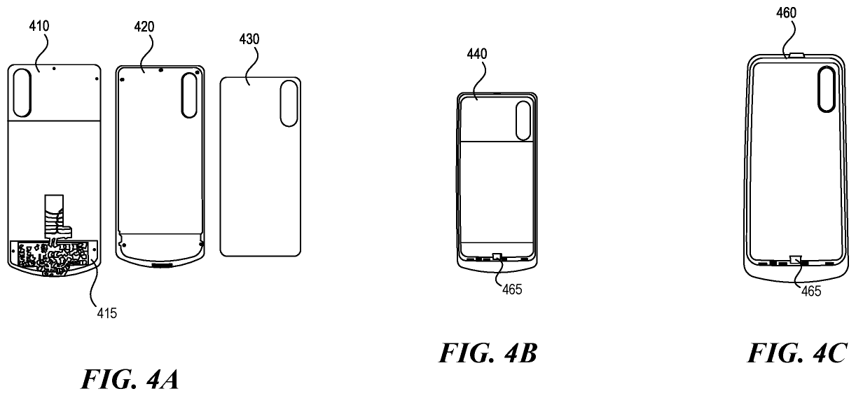

FIGS. 4A and 4B are representative perspective views of a receiver embedded in a phone case. FIG. 4C is a representative view of the fully assembled phone case. The representative embodiment shown includes the same construction as receiver in FIG. 3, but because the receiver is embedded into a case, the separation distance between the electronic device and the shielding material 220B is replaced with a low dissipation factor plastic of 0.01 or lower at around 1 MHz frequency for the second separation distance material in the phone case. The placement of this additional material between the electronic device and shielding layer can also improve performance. Structure 410 of FIG. 4A, shows an antenna and its respective PCB 415 along with the low dissipation factor separation material and shielding material. The plastic parts for the holder for the antenna in the case in structure 410 comprise a low dissipation factor material to improve performance. Structure 420 shows the back of the phone case that goes behind structure 410. When structure 420 is combined with structure 410, it looks like structure 440 in FIG. 4B. The connector plug 465 is visible in structure 440 and in the fully assembled case 460 of FIG. 4C. Structure 430 of FIG. 4A shows an overlay sheet which is the equivalent of a second separation material (or can be substituted for another layer of shielding depending on the application).

In some embodiments, an electronic device may include a wireless charging receiver as described herein. The electronic device may be any user device that uses a battery or a cell as a power source, such as a mobile phone, a portable device, etc. The electronic device may include automotive, aerospace, agricultural equipment, and industrial electronics such as electronic systems used for vehicle navigation, in-vehicle controls, automatic guided vehicles (AGVs), and plane electronics.

U.S. patent application Ser. No. 15/759,473 (Publication No. US2018/0262050), incorporated by reference in its entirety herein, describes some example coil configurations that may use the technology described herein.

A listing of solutions that is preferably implemented by some embodiments can be described using the following clauses.

Clause 1. A receiver system for a wireless charging system, comprising: a receiver antenna forming a first planar layer; a shielding material adjacent to the receiver antenna, the shielding material forming a second planar layer; and a dielectric separation material layer disposed between the receiver antenna and the shielding material layer, wherein the dielectric separation material comprises a thickness of 0.1 mm or higher and a dissipation factor of 0.01 or lower at a 1 MHz frequency, and wherein the dielectric separation material is configured to maintain an intrinsic quality factor “Q” value of the receiver antenna above a target intrinsic Q value. Some example embodiments are described with respect to FIGS. 1A to 3.

Clause 2. The receiver system of clause 1, further comprising a core disposed around or in the center of the receiver antenna to confine a magnetic flux generated by the receiver antenna to an area around the receiver antenna.

Clause 3. The receiver system of clause 1, wherein the dielectric separation material comprises a material with a dielectric constant of around 4 or lower at a 1 MHz test frequency.

Clause 4. The receiver system of clause 1, wherein the dielectric separation material comprises polypropylene plastic.

Clause 5. The receiver system of clause 1, wherein the dielectric separation material comprises polycarbonate plastic.

Clause 6. The receiver system of clause 1, wherein the shielding material comprises ferrite and the dielectric separation material comprises one or more polycarbonate sheets with a combined thickness of approximately 0.1 mm or greater.

Clause 7. The receiver system of clause 1, wherein the target intrinsic Q value is at least 100.

Clause 8. The receiver system of clause 1, wherein one or more properties of the dielectric separation material layer is selected to maintain an intrinsic efficiency of the receiver antenna when the receiver antenna is in physical contact with the dielectric separation material.

Clause 9. The receiver system of clause 1, wherein the dielectric separation material has a dissipation factor of around 0.0003 and a dielectric constant of around 2.2 at 1 MHz.

Clause 10. The receiver system of clause 1, wherein the receiver antenna is configured to receive wireless power from a wireless charging transmitter.

Clause 11. The receiver system of clause 1, wherein the receiver antenna is configured to provide power to an electronic device.

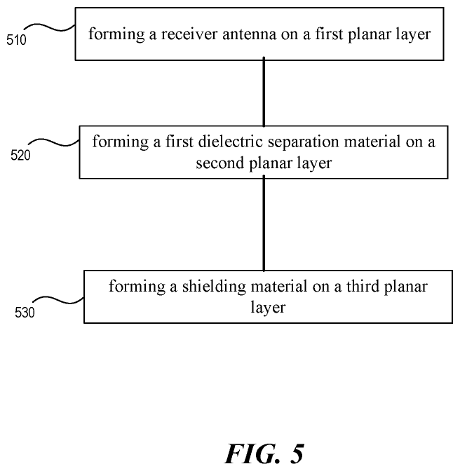

Clause 12. A method (e.g., method depicted in FIG. 5) for fabricating a receiver system for a wireless charging system, comprising: forming (510) a receiver antenna on a first planar layer; forming (520) a first dielectric separation material on a second planar layer; forming (530) a shielding material on a third planar layer, wherein the second planar layer is disposed between the first planar layer and the third planar layer, and wherein the first dielectric separation material is configured to maintain an intrinsic quality factor “Q” value of the receiver antenna above a target intrinsic Q value, and wherein the first dielectric separation material has a dissipation factor of 0.01 or lower at a 1 MHz frequency, and a thickness of 0.1 mm of larger. For example, using this method, a receiver system depicted in drawings in FIGS. 1A to 4C may be fabricated.

Clause 13. The method of clause 12, further comprising: forming a second dielectric separation material on a fourth planar layer, wherein the fourth planar layer is disposed between the third planar layer and an electronic device.

Clause 14. The method of clause 12, further comprising forming a core around or in the center of the receiver antenna to confine a magnetic flux generated by the receiver antenna to an area around the receiver antenna.

Clause 15. The method of clause 12, wherein the first dielectric separation material comprises a material with a dielectric constant of around 4 or lower at a 1 MHz test frequency.

Clause 16. The method of clause 12, wherein the first dielectric separation material comprises at least one of a polypropylene plastic or a polycarbonate plastic.

Clause 17. The method of clause 12, wherein the shielding material comprises ferrite and the first dielectric separation material comprises one or more polycarbonate sheets with a combined thickness of approximately 0.1 millimeters or greater.

Clause 18. The method of clause 12, wherein the target intrinsic Q value is at least 100.

Clause 19. The method of clause 12, wherein one or more properties of the first dielectric separation material layer is selected to maintain an intrinsic efficiency of the receiver antenna when the receiver antenna is in physical contact with the first dielectric separation material.

Clause 20. The method of clause 12, wherein the receiver antenna is configured to receive wireless power from a wireless charging transmitter and to provide the wireless power to an electronic device.

### REMARKS

The figures and above description provide a brief, general description of a suitable environment in which the invention can be implemented. The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations can perform routines having steps/blocks, or employ systems having blocks, in a different order, and some processes or blocks can be deleted, moved, added, subdivided, combined, or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further any specific numbers noted herein are only examples: alternative implementations can employ differing values or ranges. For example, for implementations, a tolerance of up to plus-minus 10 percent may be used.

These and other changes can be made to the invention considering the above Detailed Description. While the above description describes certain examples of the invention, and describes the best mode contemplated, no matter how detailed the above appears in text, the invention can be practiced in many ways. Details of the system can vary considerably in its specific implementation, while still being encompassed by the invention disclosed herein. As noted above, terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. A receiver system for a wireless charging system, comprising:
a receiver antenna forming a first planar layer;
a shielding material adjacent to the receiver antenna, the shielding material forming a second planar layer; and
a dielectric separation material disposed between the receiver antenna and the shielding material,
wherein the dielectric separation material comprises a thickness of 0.1 mm or higher and a dissipation factor of 0.01 or lower at a 1 MHz frequency, and
wherein the dielectric separation material is configured to maintain an intrinsic quality factor “Q” value of the receiver antenna above a target intrinsic Q value.

2. The receiver system of claim 1, further comprising a core disposed around or in a center of the receiver antenna to confine a magnetic flux generated by the receiver antenna to an area around the receiver antenna.

3. The receiver system of claim 1, wherein the dielectric separation material comprises a material with a dielectric constant of around 4 or lower at a 1 MHz test frequency.

4. The receiver system of claim 1, wherein the dielectric separation material comprises polypropylene plastic.

5. The receiver system of claim 1, wherein the dielectric separation material comprises polycarbonate plastic.

6. The receiver system of claim 1, wherein the shielding material comprises ferrite and the dielectric separation material comprises one or more polycarbonate sheets with a combined thickness of approximately 0.1 mm or greater.

7. The receiver system of claim 1, wherein the target intrinsic Q value is at least 100.

8. The receiver system of claim 1, wherein one or more properties of the dielectric separation material is selected to maintain an intrinsic efficiency of the receiver antenna when the receiver antenna is in physical contact with the dielectric separation material.

9. The receiver system of claim 1, wherein the dielectric separation material has a dissipation factor of around 0.0003 and a dielectric constant of around 2.2 at 1 MHz.

10. The receiver system of claim 1, wherein the receiver antenna is configured to receive wireless power from a wireless charging transmitter.

11. The receiver system of claim 1, wherein the receiver antenna is configured to provide power to an electronic device.

12. A method for fabricating a receiver system for a wireless charging system, comprising:
forming a receiver antenna on a first planar layer;
forming a first dielectric separation material on a second planar layer;
forming a shielding material on a third planar layer,
wherein the second planar layer is disposed between the first planar layer and the third planar layer, and
wherein the first dielectric separation material is configured to maintain an intrinsic quality factor “Q” value of the receiver antenna above a target intrinsic Q value, and
wherein the first dielectric separation material has a dissipation factor of 0.01 or lower at a 1 MHz frequency, and a thickness of 0.1 mm of larger.

13. The method of claim 12, further comprising:
forming a second dielectric separation material on a fourth planar layer, wherein the fourth planar layer is disposed between the third planar layer and an electronic device.

14. The method of claim 12, further comprising forming a core around or in a center of the receiver antenna to confine a magnetic flux generated by the receiver antenna to an area around the receiver antenna.

15. The method of claim 12, wherein the first dielectric separation material comprises a material with a dielectric constant of around 4 or lower at a 1 MHz test frequency.

16. The method of claim 12, wherein the first dielectric separation material comprises at least one of a polypropylene plastic or a polycarbonate plastic.

17. The method of claim 12, wherein the shielding material comprises ferrite and the first dielectric separation material comprises one or more polycarbonate sheets with a combined thickness of approximately 0.1 millimeters or greater.

18. The method of claim 12, wherein the target intrinsic Q value is at least 100.

19. The method of claim 12, wherein one or more properties of the first dielectric separation material is selected to maintain an intrinsic efficiency of the receiver antenna when the receiver antenna is in physical contact with the first dielectric separation material.

20. The method of claim 12, wherein the receiver antenna is configured to receive wireless power from a wireless charging transmitter and to provide the wireless power to an electronic device.
